(19) United States
(12) Patent Application Publication
(10) Pub. No.: US 2025/0190653 A1
(43) Pub. Date: Jun. 12, 2025

(54) DESIGN ASSISTANCE DEVICE AND DESIGN ASSISTANCE METHOD

(71) Applicants: Mitsubishi Electric Corporation, Tokyo (JP); TMEIC CORPORATION, Tokyo (JP)

(72) Inventors: Tadashi ONISHI, Tokyo (JP); Yusuke SAKAMOTO, Tokyo (JP); Toshisada MARIYAMA, Tokyo (JP); Masatsugu OYAMADA, Tokyo (JP)

(73) Assignees: Mitsubishi Electric Corporation, Tokyo (JP); TMEIC CORPORATION, Tokyo (JP)

(21) Appl. No.: 19/053,600

(22) Filed: Feb. 14, 2025

Related U.S. Application Data
(63) Continuation of application No. PCT/JP2022/032900, filed on Sep. 1, 2022.

(51) Int. Cl. G06F 30/20

(52) U.S. Cl. CPC G06F 30/20

(57) ABSTRACT

A design assistance method includes: acquiring design candidate data including design parameters as electric motor design candidates, and acquiring a first evaluation value of each piece of design candidate data; selecting top at least one piece of design candidate data having the first evaluation value relatively high as first design candidate data, and generating second design candidate data including the design parameters from the first design candidate data; calculating a second evaluation value of the first design candidate data from the design parameters included in the first design candidate data, and calculating the second evaluation value of the second design candidate data from the design parameters included in the second design candidate data; and selecting design candidate data to be used as design data of the electric motor from among the first design candidate data and the second design candidate data from the second evaluation value.

### CROSS REFERENCE TO RELATED APPLICATIONS

This application is a Continuation of PCT International Application No. PCT/JP2022/032900, filed on Sep. 1, 2022, which is hereby expressly incorporated by reference into the present application.

### TECHNICAL FIELD

The present disclosure relates to a design assistance device and a design assistance method.

### BACKGROUND ART

Design data of an electric motor includes a plurality of design parameters. Examples of the plurality of design parameters include a magnetic flux density, a winding temperature, a starting current, a torque characteristic, an allowable constraint time, efficiency, and a power factor. The plurality of design parameters may include two or more design parameters having a trade-off relationship. Two or more design parameters having a trade-off relationship affect each other, and thus it is possible that the designer of the electric motor cannot easily design the design data.

There is a design assistance device (hereinafter referred to as a “conventional design assistance device″) that assists in design of an electric motor.

A conventional design assistance device includes a storage unit and a calculating unit. The storage unit stores a plurality of pieces of design candidate data as candidates of design data of the electric motor. Each piece of design candidate data includes a plurality of design parameters.

The calculating unit calculates an evaluation value of each piece of the design candidate data on the basis of the plurality of design parameters included in each piece of the design candidate data stored in the storage unit. Then, the calculating unit selects design candidate data having the highest evaluation value from among the plurality of pieces of design candidate data stored in the storage unit as design data of the electric motor.

Meanwhile, Patent Literature 1 discloses a technique for determining an evaluation function for calculating an evaluation value.

### CITATION LIST

### Patent Literature

Patent Literature 1: JP 2014-74994 A

### SUMMARY OF INVENTION

### Technical Problem

The number of pieces of design candidate data stored in the storage unit of the conventional design assistance device is finite. Thus, it may occur that design candidate data having a higher evaluation value than the design candidate data stored in the storage unit (hereinafter referred to as “design candidate data with high evaluation″) is not stored in the storage unit. In such a case, there is a problem that the calculating unit cannot select the design candidate data with high evaluation as design data of the electric motor. Even if the conventional design assistance device determines the evaluation function for calculating an evaluation value using the technology disclosed in Patent Literature 1, it is still possible that the design candidate data with high evaluation is not stored in the storage unit.

The present disclosure has been made to solve the above problem, and an object of the present disclosure is to provide a design assistance device capable of selecting design candidate data having a higher evaluation value as design data of an electric motor in a case where there is design candidate data having a higher evaluation value than design candidate data prepared in advance.

### Solution to Problem

A design assistance device according to the present disclosure includes processing circuitry to acquire a plurality of pieces of design candidate data including a plurality of design parameters as candidates of design data of an electric motor, and to perform acquisition of a first evaluation value of each of the plurality of pieces of design candidate data, to select top at least one piece of design candidate data having the first evaluation value that is relatively high as first design candidate data from among the plurality of pieces of design candidate data, and perform generation of second design candidate data including the plurality of design parameters from each piece of the first design candidate data, to calculate a second evaluation value of each piece of the first design candidate data on a basis of the plurality of design parameters included in each piece of the first design candidate data, and calculate the second evaluation value of each piece of the second design candidate data on a basis of the plurality of design parameters included in each piece of the second design candidate data, to select design candidate data to be used as design data of the electric motor from among the plurality of pieces of first design candidate data and the plurality of pieces of second design candidate data on a basis of the second evaluation value, and to calculate the first evaluation value of each of the plurality of pieces of design candidate data using the plurality of design parameters included in each of the plurality of pieces of design candidate data, a desired level of each of the plurality of design parameters, and an ideal value of each of the plurality of design parameters, and output the first evaluation value of each of the plurality of pieces of design candidate data for the acquisition.

### Advantageous Effects of Invention

According to the present disclosure, in a case where there is design candidate data having a higher evaluation value than design candidate data prepared in advance, design candidate data having a higher evaluation value can be selected as design data of an electric motor.

### BRIEF DESCRIPTION OF DRAWINGS

FIG. 1 is a configuration diagram illustrating a design assistance system including a design assistance device 2 according to a first embodiment.

FIG. 2 is a hardware configuration diagram illustrating hardware of the design assistance device 2 according to the first embodiment.

FIG. 3 is a hardware configuration diagram of a computer in a case where the design assistance device 2 is implemented by software, firmware, or the like.

FIG. 4 is a flowchart illustrating a design assistance method which is a processing procedure performed in the design assistance device 2.

FIG. 5 is an explanatory diagram illustrating an example of an objective function g.

FIG. 6A is an explanatory diagram illustrating M design parameters g(yₘ′) included in each of N pieces of design candidate data x₁′ to x_{N}′.

FIG. 6B is an explanatory diagram illustrating M design parameters g(yₘ′) included in first design candidate data z_{1,h} (h=1, . . . , H) selected by the data generating unit 13.

FIG. 7 is an explanatory diagram illustrating Generation Example (1) of second design candidate data z_{2,j}.

FIG. 8 is an explanatory diagram illustrating Generation Example (2) of the second design candidate data z_{2,j}.

FIG. 9 is an explanatory diagram illustrating Generation Example (3) of the second design candidate data z_{2,j}.

### DESCRIPTION OF EMBODIMENTS

Hereinafter, in order to describe the present disclosure in more detail, a mode for carrying out the present disclosure will be described with reference to the accompanying drawings.

### First Embodiment

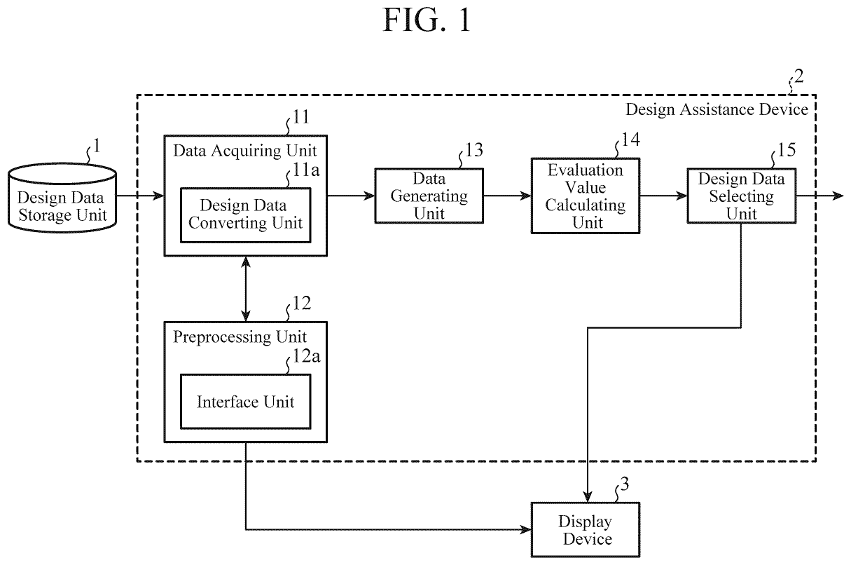

FIG. 1 is a configuration diagram illustrating a design assistance system including a design assistance device 2 according to a first embodiment.

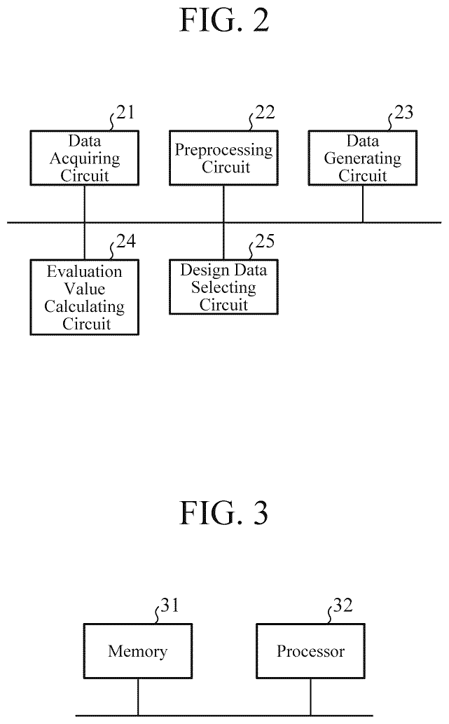

FIG. 2 is a hardware configuration diagram illustrating hardware of the design assistance device 2 according to the first embodiment.

In FIG. 1, the design assistance system includes a design data storage unit 1, a design assistance device 2, and a display device 3.

The design data storage unit 1 is implemented by, for example, a nonvolatile or volatile semiconductor memory such as a random access memory (RAM), a read only memory (ROM), a flash memory, an erasable programmable read only memory (EPROM), or an electrically erasable programmable read only memory (EEPROM), a magnetic disk, a flexible disk, an optical disk, a compact disk, a mini disk, or a digital versatile disc (DVD).

The design data storage unit 1 stores a plurality of pieces of design candidate data as candidates of design data of an electric motor. Each piece of design candidate data includes a plurality of design parameters. The design parameters are design specifications of the electric motor.

The design candidate data stored in the design data storage unit 1 is, for example, design data of an electric motor designed in the past. The design data of the electric motor designed in the past may not be used as it is as the design data of the electric motor as a current design target due to a reason that a difference in environmental conditions for installation or operating conditions between the electric motor as the current design target and the electric motor designed in the past.

Examples of the plurality of design parameters include a magnetic flux density, a winding temperature, a starting current, a torque characteristic, an allowable constraint time, efficiency, and a power factor.

Each of the magnetic flux density, the winding temperature, and the starting current is a design parameter having a design condition that it should not exceed an upper limit value. Each of the torque characteristic, the allowable constraint time, the efficiency, and the power factor is a design parameter having a design condition that it should not fall below a lower limit value.

Further, the plurality of design parameters may include two or more design parameters having a trade-off relationship. For example, in a case where, when performance of a certain design parameter among two or more design parameters is set to be increased, performance of another design parameter among the two or more design parameters is degraded, the certain design parameter and the other design parameter are in a trade-off relationship. Since the certain design parameter and the other design parameter affect each other, the designer of the electric motor may not be able to easily design the design data. For example, there is a trade-off relationship between efficiency and a torque characteristic.

The design assistance device 2 is a device that assists in the design of an electric motor.

The design assistance device 2 includes a data acquiring unit 11, a preprocessing unit 12, a data generating unit 13, an evaluation value calculating unit 14, and a design data selecting unit 15.

The display device 3 displays design candidate data, a first evaluation value, design data of the electric motor, and the like on a display (not illustrated) according to display data output from the design assistance device 2.

The data acquiring unit 11 is implemented by, for example, a data acquiring circuit 21 illustrated in FIG. 2.

The data acquiring unit 11 includes a design data converting unit 11a.

The data acquiring unit 11 acquires a plurality of pieces of design candidate data from the design data storage unit 1, and acquires the first evaluation value of each piece of the design candidate data from the preprocessing unit 12.

The design data converting unit 11a converts each design parameter by substituting each design parameter included in each piece of the design candidate data into an objective function.

The objective function is a function that outputs the design parameter after conversion when the design parameter is substituted. Further, the objective function is, for example, a function having a local minimum value, and is a function in which the first evaluation value is minimized near an upper limit value within an upper/lower limit range or near a lower limit value within the upper/lower limit range.

The data acquiring unit 11 outputs a plurality of pieces of the design candidate data including a plurality of design parameters after conversion to each of the preprocessing unit 12 and the data generating unit 13, and outputs a first evaluation value of each piece of the design candidate data to the data generating unit 13.

In the design assistance device 2 illustrated in FIG. 1, the data acquiring unit 11 includes the design data converting unit 11a. Here, this is merely an example, and the design data converting unit 11a may be provided outside the data acquiring unit 11.

The preprocessing unit 12 is implemented by, for example, a preprocessing circuit 22 illustrated in FIG. 2.

The preprocessing unit 12 includes an interface unit 12a.

The interface unit 12a is, for example, a man-machine interface implemented by a mouse, a keyboard, or a touch panel.

The interface unit 12a performs a process of receiving a setting of a desired level of each design parameter acquired by the data acquiring unit 11 and a process of receiving correction of the desired level.

Further, the interface unit 12a performs processing of receiving a setting of ideal values of respective design parameters.

The preprocessing unit 12 calculates a first evaluation value of each piece of the design candidate data by using a plurality of design parameters included in each piece of the design candidate data acquired by the data acquiring unit 11, a desired level of each design parameter, and an ideal value of each design parameter.

The preprocessing unit 12 outputs the first evaluation value of each piece of the design candidate data to the data acquiring unit 11.

Further, the preprocessing unit 12 generates display data for displaying each piece of the design candidate data acquired by the data acquiring unit 11 and the first evaluation value of each piece of the design candidate data, and outputs the display data to the display device 3.

In the design assistance device 2 illustrated in FIG. 1, the preprocessing unit 12 includes the interface unit 12a. Here, this is merely an example, and the interface unit 12a may be provided outside the preprocessing unit 12.

Further, in the design assistance device 2 illustrated in FIG. 1, the preprocessing unit 12 generates display data for displaying each piece of the design candidate data including a plurality of design parameters after conversion. Here, this is merely an example, and the preprocessing unit 12 may acquire each piece of the design candidate data stored in the design data storage unit 1 from the data acquiring unit 11 and generate display data for displaying each piece of the design candidate data.

Further, in the design assistance device 2 illustrated in FIG. 1, the preprocessing unit 12 calculates the first evaluation value of each piece of the design candidate data by using the plurality of design parameters after conversion included in each piece of the design candidate data, the desired level of each design parameter, and the ideal value of each design parameter. Here, this is merely an example, and the preprocessing unit 12 may calculate the first evaluation value of each piece of the design candidate data by using a plurality of design parameters included in each piece of the design candidate data stored in the design data storage unit 1, a desired level of each design parameter, and an ideal value of each design parameter.

The data generating unit 13 is implemented by, for example, a data generating circuit 23 illustrated in FIG. 2.

The data generating unit 13 acquires a plurality of pieces of design candidate data including a plurality of design parameters after conversion from the data acquiring unit 11.

The data generating unit 13 selects top at least one piece of design candidate data having a relatively high first evaluation value as first design candidate data from among the plurality of pieces of design candidate data.

In the design assistance device 2 illustrated in FIG. 1, the data generating unit 13 acquires a plurality of pieces of design candidate data including a plurality of design parameters after conversion from the data acquiring unit 11. Here, this is merely an example, and the data generating unit 13 may acquire a plurality of pieces of design candidate data stored in the design data storage unit 1 from the data acquiring unit 11.

The data generating unit 13 generates second design candidate data including a plurality of design parameters from each piece of the first design candidate data.

Specifically, the data generating unit 13 generates each piece of the second design candidate data in such a manner that a value of any design parameter among the plurality of design parameters included in each piece of the second design candidate data is different from a value of a design parameter corresponding to the any design parameter included in the first design candidate data being a generation source.

The data generating unit 13 outputs each piece of the first design candidate data and each piece of the second design candidate data to the evaluation value calculating unit 14.

The evaluation value calculating unit 14 is implemented by, for example, an evaluation value calculating circuit 24 illustrated in FIG. 2.

The evaluation value calculating unit 14 calculates the second evaluation value of each piece of the first design candidate data on the basis of the plurality of design parameters included in each piece of the first design candidate data selected by the data generating unit 13.

The evaluation value calculating unit 14 calculates the second evaluation value of each piece of the second design candidate data on the basis of the plurality of design parameters included in each piece of the second design candidate data generated by the data generating unit 13.

The evaluation value calculating unit 14 outputs each piece of the first design candidate data, the second evaluation value of each piece of the first design candidate data, each piece of the second design candidate data, and the second evaluation value of each piece of the second design candidate data to the design data selecting unit 15.

The design data selecting unit 15 is implemented by, for example, a design data selecting circuit 25 illustrated in FIG. 2.

The design data selecting unit 15 selects design candidate data to be used as design data of the electric motor from among the plurality of pieces of first design candidate data and the plurality of pieces of second design candidate data on the basis of the second evaluation value calculated by the evaluation value calculating unit 14.

The design data selecting unit 15 outputs the design data of the electric motor to, for example, a design data management device which is not illustrated.

Further, the design data selecting unit 15 generates display data for displaying the design data of the electric motor, and outputs the display data to the display device 3.

In FIG. 1, it is assumed that each of the data acquiring unit 11, the preprocessing unit 12, the data generating unit 13, the evaluation value calculating unit 14, and the design data selecting unit 15, which are components of the design assistance device 2, is implemented by dedicated hardware as illustrated in FIG. 2. That is, it is assumed that the design assistance device 2 is implemented by the data acquiring circuit 21, the preprocessing circuit 22, the data generating circuit 23, the evaluation value calculating circuit 24, and the design data selecting circuit 25.

Each of the data acquiring circuit 21, the preprocessing circuit 22, the data generating circuit 23, the evaluation value calculating circuit 24, and the design data selecting circuit 25 corresponds to, for example, a single circuit, a composite circuit, a programmed processor, a parallel-programmed processor, an application specific integrated circuit (ASIC), a field-programmable gate array (FPGA), or a combination thereof.

The components of the design assistance device 2 are not limited to those implemented by dedicated hardware, and the design assistance device 2 may be implemented by software, firmware, or a combination of software and firmware.

The software or firmware is stored in a memory of the computer as a program. The computer means hardware that executes a program, and corresponds to, for example, a central processing unit (CPU), a graphics processing unit (GPU), a central processor, a processing unit, an arithmetic unit, a microprocessor, a microcomputer, a processor, or a digital signal processor (DSP).

FIG. 3 is a hardware configuration diagram of a computer in a case where the design assistance device 2 is implemented by software, firmware, or the like.

In a case where the design assistance device 2 is implemented by software, firmware, or the like, a program for causing a computer to execute each processing procedure performed in the data acquiring unit 11, the preprocessing unit 12, the data generating unit 13, the evaluation value calculating unit 14, and the design data selecting unit 15 is stored in a memory 31. Then, a processor 32 of the computer executes the program stored in the memory 31.

Further, FIG. 2 illustrates an example in which each of the components of the design assistance device 2 is implemented by dedicated hardware, and FIG. 3 illustrates an example in which the design assistance device 2 is implemented by software, firmware, or the like. Here, this is merely an example, and some components in the design assistance device 2 may be implemented by dedicated hardware, and the remaining components may be implemented by software, firmware, or the like.

Next, the operation of the design assistance device 2 illustrated in FIG. 1 will be described.

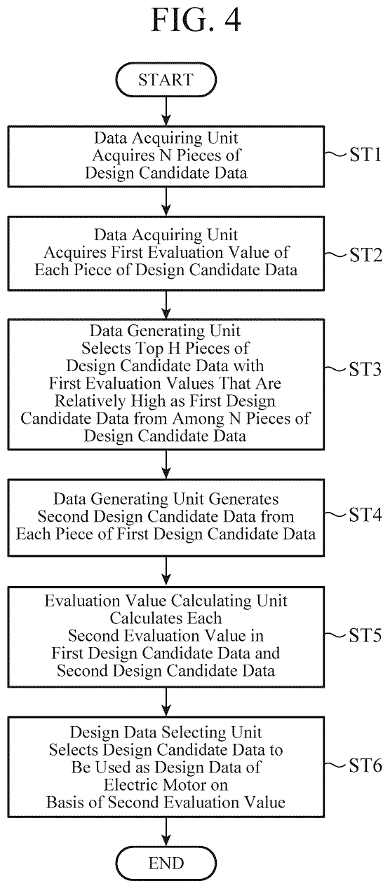

FIG. 4 is a flowchart illustrating a design assistance method which is a processing procedure performed in the design assistance device 2.

The data acquiring unit 11 acquires N pieces of design candidate data xₙ as candidates of design data of the electric motor from the design data storage unit 1 (step ST1 in FIG. 4). n=1, . . . , N, and N is an integer equal to or more than 2.

The design candidate data xₙ includes a design parameter yₘ. m=1, . . . , M, and M is an integer equal to or more than 2.

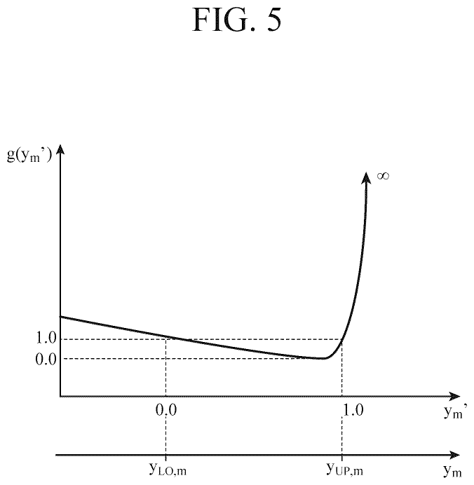

The design data converting unit 11a of the data acquiring unit 11 stores, for example, an objective function g as illustrated in FIG. 5.

FIG. 5 is an explanatory diagram illustrating an example of the objective function g.

In FIG. 5, the horizontal axis represents the design parameter yₘ, and the vertical axis represents g(yₘ′) indicating the value of the objective function g. yₘ′ is obtained by normalizing the design parameter yₘ.

As illustrated in FIG. 5, the objective function g is a function having a local minimum value. In the example of FIG. 5, a local minimum value is present where the normalized design parameter yₘ′ is close to 1.0. Here, the waveform of the objective function g illustrated in FIG. 5 is deformed and does not completely match the actual waveform.

In the example of FIG. 5, the upper/lower limit range of the design parameter g(yₘ′) after conversion, which is a value of the objective function g, is 0.0 to 1.0. The objective function g is a function that minimizes the first evaluation value V₁ near the upper limit value within the upper/lower limit range or near the lower limit value within the upper/lower limit range.

If the design parameter yₘ included in the design candidate data x₁ is a design parameter having a design condition that the design parameter yₘ should not exceed the upper limit value y_{UP,m}, the design data converting unit 11a normalizes the design parameter yₘ as expressed in the following Expression (1). The design parameter having a design condition that the upper limit value y_{UP,m} should not be exceeded is, for example, a magnetic flux density, a winding temperature, or a starting current.

If the design parameter yₘ included in the design candidate data xₙ is a design parameter having a design condition that the design parameter yₘ should not fall below the lower limit value y_{LO,m}, the design data converting unit 11a normalizes the design parameter yₘ as expressed in the following Expression (2). The design parameter that should not fall below the lower limit value y_{LO,m} is, for example, a torque characteristic or an allowable constraint time.

In the normalization of the design parameter yₘ illustrated in Expression (1), when yₘ=y_{UP,m}, the normalized design parameter yₘ′ is “1”, and when yₘ=y_{LO,m}, the normalized design parameter yₘ′ is “0”.

Further, in the normalization of the design parameter yₘ illustrated in Expression (2), when yₘ=y_{UP,m}, the normalized design parameter yₘ′ is “0”, and when yₘ=y_{LO,m}, the normalized design parameter yₘ′ is “1”.

$${y}_{m}^{′} = \frac{{y}_{m} - {y}_{LO , m}}{{y}_{UP , m} - {y}_{LO , m}} \qquad ( 1 )$$

$${y}_{m}^{′} = \frac{{y}_{UP , m} - {y}_{m}}{{y}_{UP , m} - {y}_{LO , m}} \qquad ( 2 )$$

The design data converting unit 11a converts the normalized design parameter yₘ′ by substituting the normalized design parameter yₘ′ included in the design candidate data xₙ into the objective function g as expressed in the following Expression (3) to obtain the design parameter g(yₘ′) after conversion.

$$g ( {y}_{m}^{′} ) = 1 - {y}_{m}^{′} + {μ}_{1} \cdot {P}_{1} ( {y}_{m}^{′} ) \qquad ( 3 )$$

$${P}_{1} ( {y}_{m}^{′} ) = \{ \begin{matrix}0 , ( {y}_{m}^{′} \leq {γ}_{m} ) \\ {( {y}_{m}^{′} - {γ}_{m} )}^{2} , ( {y}_{m}^{′} > {γ}_{m} )\end{matrix}$$

$${μ}_{1} = \frac{1}{{( 1 - {γ}_{m} )}^{2}}$$

In Expression (3), Tₘ is a threshold value.

When y_{LO,m}<yₘ′ y_{UP,m}, 0 Kg (yₘ′)<1, and when yₘ′ is approximately equal to y_{UP,m}, g(yₘ′) is approximately 1.0. Further, when yₘ′>y_{UP,m}, g(yₘ′) is infinite.

The data acquiring unit 11 outputs the design candidate data xₙ′ (n=1, . . . , N) including the design parameters g(y₁′) to g(y_{M}′) after conversion by the design data converting unit 11a to the preprocessing unit 12.

The preprocessing unit 12 acquires design candidate data xₙ′ (n=1, . . . , N) from the data acquiring unit 11.

The interface unit 12a of the preprocessing unit 12 receives a setting of a desired level fₘ^{asp} of the normalized design parameter yₘ′ (m=1, . . . , M) included in the design candidate data xₙ′.

Specifically, for example, when the designer of the electric motor performs an operation of setting the desired level fₘ^{asp} of the design parameter yₘ′ using the interface unit 12a, the interface unit 12a receives the setting of the desired level fₘ^{a}P. The desired level fₘ^{asp} indicates a level desired by the designer, and is a level lower than an ideal value fₘ^{ideal}. For example, the designer of the electric motor can obtain the M desired levels f₁^{asp} to f_{Ma}p by using a desired level method such as a satisfying trade-off method.

Further, the interface unit 12a receives the setting of the ideal value fₘ^{ideal} of the normalized design parameter yₘ′ included in the design candidate data xₙ′.

Specifically, for example, when the designer of the electric motor performs an operation of setting the ideal value fₘ^{ideal} of the design parameter yₘ′ using the interface unit 12a, the interface unit 12a receives the setting of the ideal value fₘ^{ideal}.

For example, the preprocessing unit 12 calculates the first evaluation value V₁ of the design candidate data xₙ′ by substituting the design parameter g(yₘ′) after conversion, the desired level fₘ^{asp}, and the ideal value fₘ^{ideal} into an evaluation function expressed by the following Expression (4).

$${V}_{n} = \begin{matrix}max \\ m\end{matrix} ( \frac{g ( {y}_{m}^{′} ) - {f}_{m}^{asp}}{{f}_{m}^{asp} - {f}_{m}^{ideal}} ) \qquad ( 4 )$$

In Expression (4), max is a mathematical symbol that searches for m having a maximum value in ( ) among m=1, . . . , M, and sets the maximum value as V₁.

In the design assistance device 2 illustrated in FIG. 1, the preprocessing unit 12 calculates the first evaluation value V₁ of the design candidate data xₙ′ by using the evaluation function illustrated in Expression (4). Here, this is merely an example, and the preprocessing unit 12 may calculate the first evaluation value V₁ using an evaluation function other than Expression (4). The evaluation function other than Expression (4) may include, for example, an installation condition or an operation condition of the electric motor.

For example, the preprocessing unit 12 sorts the N pieces of design candidate data x₁′ to x_{N}′ in descending order of the first evaluation value Vₙ, generates display data for displaying the sorted design candidate data x₁′ to x_{N}′, and outputs the display data to the display device 3.

The display device 3 displays the sorted design candidate data x₁′ to x_{N}′ on a display (not illustrated).

For example, the designer of the electric motor checks the sorted design candidate data x₁′ to x_{N}′ displayed on the display.

When the N pieces of design candidate data x₁′ to x_{N}′ are not sorted as intended, the designer of the electric motor can perform an operation of correcting the desired level fₘ^{asp} of the design parameter yₘ′ using the interface unit 12a.

When the interface unit 12a receives the correction of the desired level fₘ^{asp}, the preprocessing unit 12 calculates the first evaluation value V₁ of the design candidate data xₙ′ again using the corrected desired level fₘ^{asp}.

When the N pieces of design candidate data x₁′ to x_{N}′ are sorted as intended by the designer, the preprocessing unit 12 outputs the first evaluation value V₁ (n=1, . . . , N) of the design candidate data x₁′ to the data acquiring unit 11.

The data acquiring unit 11 acquires the first evaluation value V₁ (n=1, . . . , N) of the design candidate data x₁′ from the preprocessing unit 12 (step ST2 in FIG. 4).

The data acquiring unit 11 outputs the design candidate data xₙ′ and the first evaluation value Vₙ to the data generating unit 13.

The data generating unit 13 acquires the design candidate data x₁′ (n=1, . . . , N) and the first evaluation value V₁ from the data acquiring unit 11.

The data generating unit 13 selects top H pieces of design candidate data with the first evaluation value V₁ that is relatively high as first design candidate data z_{1,h} from among the N pieces of design candidate data x₁′ to x_{N}′ (step ST3 in FIG. 4). h=1, . . . , H. H is an integer equal to or more than 1.

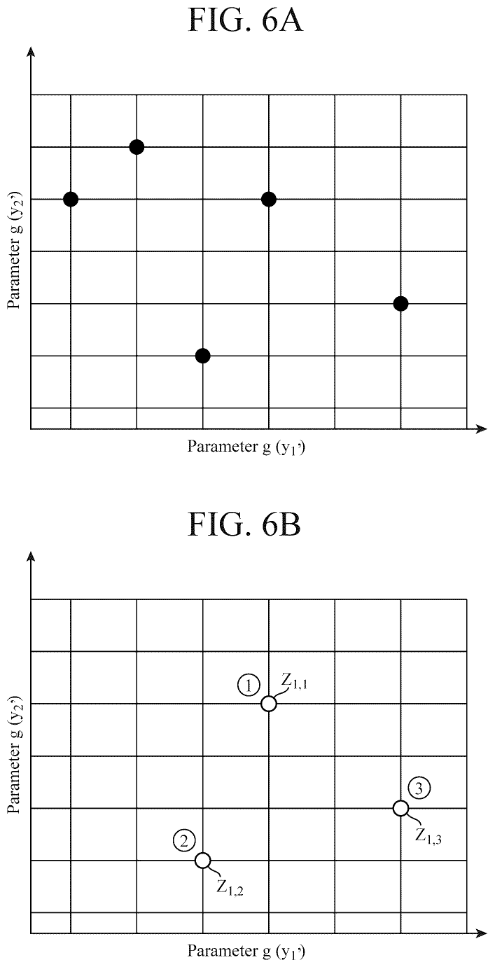

FIG. 6A is an explanatory diagram illustrating M design parameters g(yₘ′) included in each of the N pieces of design candidate data x₁′ to x_{N}′. In the example of FIG. 6A, N=5 and M=2.

FIG. 6B is an explanatory diagram illustrating M design parameters g(yₘ′) included in the first design candidate data z_{1,h} (h=1, . . . , H) selected by the data generating unit 13. In the example of FIG. 6B, H=3 and M=2.

In FIGS. 6A and 6B, the horizontal axis represents the design parameter g(y₁′), and the vertical axis represents the design parameter g(y₂′). • indicates the design candidate data xₙ′ (n=1, . . . , 5), and ∘ indicates the first design candidate data z_{1,h} (h=1, 2, and 3).

The circled numbers indicate the descending order of the first evaluation values V₁. The evaluation value of the circled number=1 is the evaluation value V₁ of the first design candidate data z_{1,1}, and is the highest among the first evaluation values V₁ to V₃.

The evaluation value of the circled number=2 is the evaluation value V₂ of the first design candidate data z_{1,2}, and is the second highest among the first evaluation values V₁ to V₃. The evaluation value of the circled number=3 is the evaluation value V₃ of the first design candidate data z_{1,3}, and is the third highest among the first evaluation values V₁ to V₃.

The evaluation value of the design candidate data present around the first design candidate data z_{1,h} having a high first evaluation value V₁ is often higher than the evaluation value of the design candidate data present far from the first design candidate data z_{1,h}.

The data generating unit 13 generates second design candidate data z_{2,j} (j=1, . . . , J) including M design parameters from the first design candidate data z_{1,h} (step ST4 in FIG. 4). J is an integer equal to or more than 1.

Specifically, the data generating unit 13 generates the second design candidate data z₂,j in such a manner that the value of any design parameter g(yₘ″) among the M design parameters g(y₁″) to g(y_{M}″) included in the second design candidate data z₂,j is different from the value of the design parameter g(yₘ′) included in the first design candidate data z_{1,h} as a generation source.

The data generating unit 13 outputs the first design candidate data z_{1,h} and the second design candidate data z₂,j to the evaluation value calculating unit 14.

Hereinafter, a specific generation example of the second design candidate data z_{2,j} by the data generating unit 13 will be described.

### Generation Example (1)

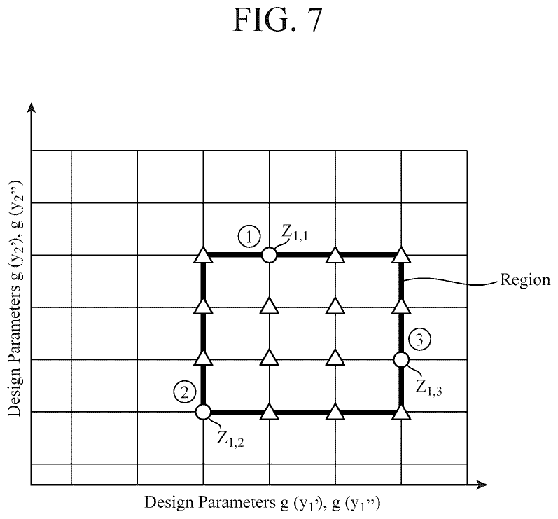

When H=3, the data generating unit 13 sets a region surrounded by the first design candidate data z_{1,1}, the first design candidate data z_{1,2}, and the first design candidate data z_{1,3} as illustrated in FIG. 7.

FIG. 7 is an explanatory diagram illustrating Generation Example (1) of the second design candidate data z_{2,j}.

In FIG. 7, the horizontal axis represents the design parameter g(y₁′) included in the first design candidate data z_{1,h} and the design parameter g(y₁″) included in the second design candidate data z_{2,j}. The vertical axis represents the design parameter g(y₂′) included in the first design candidate data z_{1,h} and the design parameter g(y₂′) included in the second design candidate data z_{2,j}.

A black thick line indicates a rectangular region surrounded by the first design candidate data z_{1,1}, the first design candidate data z_{1,2}, and the first design candidate data z_{1,3}. Here, a black thick line indicates a rectangular region. Here, this is merely an example, and for example, the black thick line may indicate a triangular region in which each piece of the first design candidate data z_{1,1}, the first design candidate data z_{1,2}, and the first design candidate data z_{1,3} is present at the vertex. Therefore, the data generating unit 13 may set an H-gonal region in which each of the H pieces of first design candidate data z_{1,1} to z_{1,H} selected by the data generating unit 13 is present at the vertex.

Each A present in the region is design candidate data including a design parameter g(yₘ′) different from any of the design parameters g(yₘ′) included in the first design candidate data z_{1,h}. In the example of FIG. 7, there are 13 A in the region.

In FIG. 7, for example, A present to the left of the first design candidate data z_{1,1} includes the design parameter g(y₂″) having the same value as the design parameter g(y₂′) included in the first design candidate data z_{1,1} but does not include the design parameter g(y₁″) having the same value as the design parameter g(y₁′) included in the first design candidate data z_{1,1}. The A includes a design parameter g(y₁″) having a smaller value than the design parameter g(y₁′), for example, by the resolution of the design parameter g(y₁′).

For example, A present above and adjacent to the first design candidate data z_{1,2} includes the design parameter g(y₁″) having the same value as the design parameter g(y₁′) included in the first design candidate data z_{1,2}, but does not include the design parameter g(y₂″) having the same value as the design parameter g(y₂′) included in the first design candidate data z_{1,2}. The A includes a design parameter g(y₂″) having a larger value than the design parameter g(y₂′), for example, by the resolution of the design parameter g(y₂′).

The data generating unit 13 generates all of the 13 Δ present in the region as the second design candidate data z_{2,j} (j=1, . . . , J).

Here, in a case where the upper limit number of the second design candidate data z_{2,j} is determined, the data generating unit 13 selects A having a relatively high first evaluation value V₁ corresponding to the upper limit number from the 13 Δ, and generates each of the selected Δ corresponding to the upper limit number as the second design candidate data z₂,j (j=1, . . . , J). In this case, J is the upper limit number of the second design candidate data z_{2,j}.

The first evaluation value V₁ of each A is calculated, for example, by the data generating unit 13 using Expression (4) similarly to the preprocessing unit 12. In this case, the data generating unit 13 needs to have acquired the desired level fₘ^{asp} and the ideal value fₘ^{ideal} from the preprocessing unit 12.

### Generation Example (2)

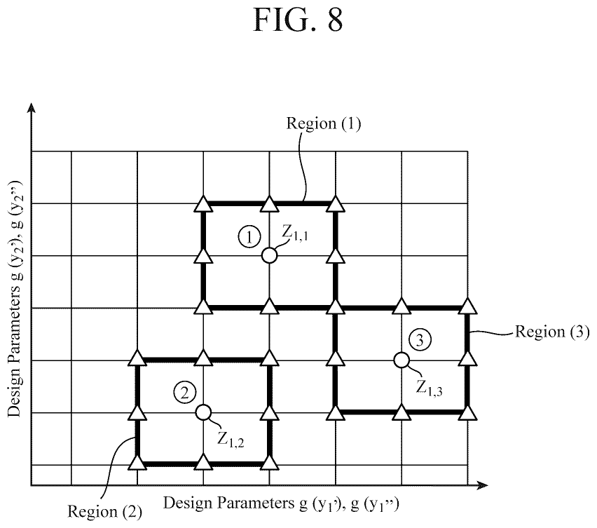

As illustrated in FIG. 8, the data generating unit 13 sets a region surrounding each piece of the first design candidate data z₁,h (h=1, . . . , H).

FIG. 8 is an explanatory diagram illustrating Generation Example (2) of the second design candidate data z_{2,j}.

In FIG. 8, the horizontal axis represents the design parameter g(y₁′) included in the first design candidate data z₁,h and the design parameter g(y₁″) included in the second design candidate data z_{2,j}. The vertical axis represents the design parameter g(y₂′) included in the first design candidate data z₁,h and the design parameter g(y₂″) included in the second design candidate data z_{2,j}.

The region (1) is a region surrounding the first design candidate data z_{1,1}, and the region (2) is a region surrounding the first design candidate data z_{1,2}. Further, the region (3) is a region surrounding the first design candidate data z_{1,3}.

In the example of FIG. 8, the sizes of the regions (1) to (3) are the same as each other, and each of the regions (1) to (3) includes eight Δ.

Here, this is merely an example, and the sizes of the regions (1) to (3) may be different from each other. Further, the shape of each of the regions (1) to (3) is not limited to a quadrangle, and may be a polygon other than the quadrangle.

The data generating unit 13 generates all of the eight Δ present in each of the regions (1) to (3) as the second design candidate data z_{2,j} (j=1, . . . , J).

However, in a case where the upper limit number of the second design candidate data z₂,j is determined, the data generating unit 13 selects A having a relatively high first evaluation value V₁ corresponding to the upper limit number from 23 (=8×3−1) Δ, and generates each of the selected Δ corresponding to the upper limit number as the second design candidate data z_{2,j} (j=1, . . . , J). A present at the upper left vertex of the region (3) overlaps Δ present at the lower right vertex of the region (1). Therefore, here, A having a relatively high first evaluation value V₁ corresponding to the upper limit number are selected from 23 (=8×3-1) A instead of 24 (=8×3) A. Also in this case, for example, the data generating unit 13 calculates the first evaluation value V₁ of each A using Expression (4) similarly to the preprocessing unit 12.

Further, in a case where the upper limit number of the second design candidate data z_{2,j} is determined, the data generating unit 13 calculates the number Sel(n) of the second design candidate data selectable from each of the regions (1) to (3) on the basis of the first evaluation value V₁ (n=1, 2, 3).

For example, when the upper limit number is L and 0<V₁<1.0, the number Sel(n) is calculated as the following Expression (5).

Sel(n)=L×Vₙ/1.0 (5)

For example, if L=10, V₁=0.5, V₂=0.3, and V₂=0.2, the data generating unit 13 calculates “5” as the number Sel(1) of second design candidate data selectable from the region (1). Further, the data generating unit 13 calculates “3” as the number Sel(2) of second design candidate data selectable from the region (2), and calculates “2” as the number Sel(3) of second design candidate data selectable from the region (3).

In this example, the data generating unit 13 generates each of A of Sel(1) (=5) having a relatively high first evaluation value V₁ among the eight Δ present in the region (1) as the second design candidate data z₂,j.

Further, the data generating unit 13 generates each of A of Sel(2) (=3) having a relatively high first evaluation value V₁ among the eight Δ present in the region (2) as the second design candidate data z₂,j.

Further, the data generating unit 13 generates each of A of Sel(3) (=2) having a relatively high first evaluation value V₁ among the eight Δ present in the region (3) as the second design candidate data z₂,j.

### Generation Example (3)

In Generation Example (2), the data generating unit 13 sets a region in which each piece of the first design candidate data z_{1,h} (h=1, . . . , H) is present at the center.

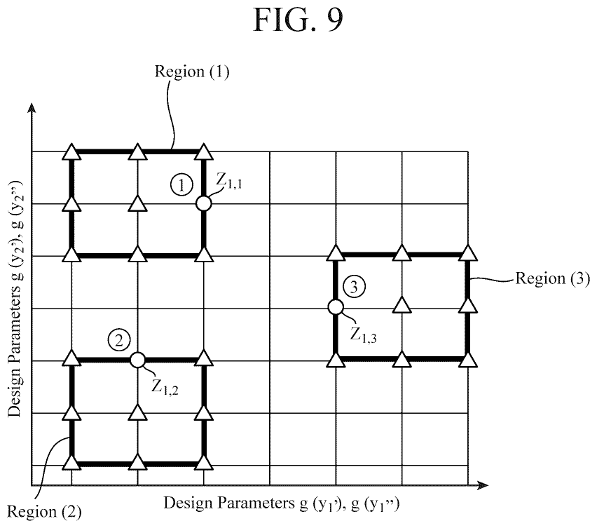

Here, this is merely an example, and the data generating unit 13 may set the regions (1) to (3) in such a manner that each piece of the first design candidate data z_{1,h} (h=1, . . . , H) is present near the boundary of the region as illustrated in FIG. 9.

Generation Example (3) is similar to Generation Example (2) except for the region setting.

FIG. 9 is an explanatory diagram illustrating Generation Example (3) of the second design candidate data z₂,j.

In FIG. 9, the horizontal axis represents the design parameter g(y₁′) included in the first design candidate data z_{1,h} and the design parameter g(y₁″) included in the second design candidate data z₂,j. The vertical axis represents the design parameter g(y₂′) included in the first design candidate data z_{1,h} and the design parameter g(y₂″) included in the second design candidate data z_{2,j}.

The evaluation value calculating unit 14 acquires the first design candidate data z_{1,h} (h=1, . . . , H) and the second design candidate data z_{2,j} (j=1, . . . , J) from the data generating unit 13.

The evaluation value calculating unit 14 calculates the second evaluation value E_{1,h} of the first design candidate data z_{1,h} on the basis of the normalized design parameters yₘ′ (m=1, . . . , M) included in the first design candidate data z_{1,h} as expressed in the following Expression (6) (step ST5 in FIG. 4).

$${E}_{1 , h} = \begin{matrix}sum \\ m\end{matrix} ( \frac{g ( {y}_{m}^{′} ) - {f}_{m}^{asp}}{{f}_{m}^{asp} - {f}_{m}^{ideal}} ) \qquad ( 6 )$$

In Expression (6), sum is a mathematical symbol in which the total value of the values in ( ) in each of m=1, . . . , M is E_{1,h}.

The evaluation value calculating unit 14 calculates the second evaluation value E₂,j of the second design candidate data z₂,j on the basis of the design parameter yₘ″ (m=1, . . . , M) included in the second design candidate data z₂,j as expressed in the following Expression (7) (step ST5 in FIG. 4).

$${E}_{2 , h} = \begin{matrix}sum \\ m\end{matrix} ( \frac{g ( {y}_{m}^{″} ) - {f}_{m}^{asp}}{{f}_{m}^{asp} - {f}_{m}^{ideal}} ) \qquad ( 7 )$$

The evaluation value calculating unit 14 outputs the first design candidate data z_{1,h} (h=1, . . . , H), the second evaluation value E₁,h of the first design candidate data z_{1,h}, the second design candidate data z₂,j (j=1, . . . , J), and the second evaluation value E₂,j of the second design candidate data z₂,j to the design data selecting unit 15.

The design data selecting unit 15 acquires the first design candidate data z_{1,h} (h=1, . . . , H), the second evaluation value E₁,h of the first design candidate data z_{1,h}, the second design candidate data z₂,j (j=1, . . . , J), and the second evaluation value E₂,j of the second design candidate data z₂,j from the evaluation value calculating unit 14.

The design data selecting unit 15 selects design candidate data to be used as design data of the electric motor from among the first design candidate data z_{1,1} to z_{1,H} and the second design candidate data z_{2,1} to z₂,J on the basis of the second evaluation value E_{1,h} (h=1, . . . , H) and the second evaluation value E₂,j (j=1, . . . , J) (step ST6 in FIG. 4).

Specifically, the design data selecting unit 15 specifies the highest second evaluation value by comparing the second evaluation values E_{1,1} to E_{1,H}, E_{2,1} to E_{2,J} with each other.

Then, the design data selecting unit 15 selects, as design data of the electric motor, the design candidate data corresponding to the highest second evaluation value from among the first design candidate data z_{1,1} to z₁,H and the second design candidate data z_{2,1} to z_{2,J}.

The design data selecting unit 15 outputs the design data of the electric motor to, for example, the design data management device which is not illustrated.

Further, the design data selecting unit 15 generates display data for displaying the design data of the electric motor, and outputs the display data to the display device 3.

In the first embodiment described above, the design assistance device 2 is configured to include the data acquiring unit 11 to acquire a plurality of pieces of design candidate data including a plurality of design parameters as candidates of design data of an electric motor, and acquire a first evaluation value of each piece of the design candidate data, and the data generating unit 13 to select top at least one piece of design candidate data with the first evaluation value that is relatively high as first design candidate data from among the plurality of pieces of design candidate data acquired by the data acquiring unit 11, and generate second design candidate data including the plurality of design parameters from each piece of the first design candidate data.

Further, the design assistance device 2 includes the evaluation value calculating unit 14 to calculate a second evaluation value of each piece of the first design candidate data on the basis of a plurality of design parameters included in each piece of the first design candidate data, and calculate a second evaluation value of each piece of the second design candidate data on the basis of a plurality of design parameters included in each piece of the second design candidate data, and the design data selecting unit 15 to select design candidate data to be used as design data of the electric motor from among the plurality of pieces of first design candidate data and the plurality of pieces of second design candidate data on the basis of the second evaluation value calculated by the evaluation value calculating unit 14. Therefore, in a case where there is design candidate data having a higher evaluation value than design candidate data prepared in advance, the design assistance device 2 can select design candidate data having a higher evaluation value as the design data of the electric motor.

Further, in the first embodiment, the design assistance device 2 is configured to include the preprocessing unit 12 to calculate a first evaluation value of each piece of the design candidate data using a plurality of design parameters included in each piece of the design candidate data acquired by the data acquiring unit 11, a desired level of each of the design parameters, and an ideal value of each of the design parameters, and output the first evaluation value of each piece of the design candidate data to the data acquiring unit 11. Therefore, in the design assistance device 2, the probability that the top at least one piece of design candidate data selected by the data generating unit 13 is design candidate data including a design parameter having a high possibility of achieving performance desired by the designer is improved. Further, the probability that the second design candidate data generated by the data generating unit 13 is design candidate data including a design parameter having a high possibility of achieving performance desired by the designer is improved.

In the first embodiment, the design assistance device 2 is configured in such a manner that the preprocessing unit 12 includes the interface unit 12a to receive a setting of a desired level of each of the design parameters acquired by the data acquiring unit 11. Therefore, the design assistance device 2 allows the designer to set a desired level.

Further, in the first embodiment, the preprocessing unit 12 generates display data for displaying each piece of the design candidate data acquired by the data acquiring unit 11 and the first evaluation value of each piece of the design candidate data, and outputs the display data to the display device 3. Then, the design assistance device 2 is configured in such a manner that the interface unit 12a receives correction of the desired level of each of the design parameters acquired by the data acquiring unit 11.

Therefore, in the design assistance device 2, for example, the designer can select desired design candidate data as the first design candidate data.

In the design assistance device 2 illustrated in FIG. 1, the design data converting unit 11a converts the normalized design parameter yₘ′ using the objective function g that minimizes the first evaluation value V₁ near the upper limit value within the upper/lower limit range or near the lower limit value within the upper/lower limit range.

Here, this is merely an example, and in a case where the normalized design parameter yₘ′ is a design parameter that is better as its value is higher if the normalized design parameter yₘ′ is larger than the lower limit value, the design data converting unit 11a may convert the normalized design parameter yₘ′ using the objective function g as expressed in the following Expression (8). The design parameter that is better as its value is higher is, for example, efficiency or power factor.

$$g ( {y}_{m}^{′} ) = {y}_{m}^{′} + {μ}_{2} \cdot {P}_{2} ( {y}_{m}^{′} ) \qquad ( 8 )$$

$${P}_{2} ( {y}_{m}^{′} ) = \{ \begin{matrix}0 , ( {y}_{m}^{′} \leq {γ}_{m} ) \\ {( {y}_{m}^{′} - {γ}_{m} )}^{2} , ( {y}_{m}^{′} > {γ}_{m} )\end{matrix}$$

$${μ}_{2} = \frac{1}{{( {10}^{- 10} )}^{2}}$$

In Expression (8), when yₘ′>y_{LO,m}, g(yₘ′)<1.

In the design assistance device 2 illustrated in FIG. 1, the evaluation value calculating unit 14 calculates the second evaluation value E₁,h of the first design candidate data z_{1,h} according to Expression (6), and calculates the second evaluation value E₂,J of the second design candidate data z₂,j according to Expression (7).

Here, this is merely an example, and the evaluation value calculating unit 14 may calculate the second evaluation value E₁,h of the first design candidate data z_{1,h} according to the following Expression (9) and calculate the second evaluation value E₂,j of the second design candidate data z₂,j according to the following Expression (10).

$${E}_{1 , h} = \begin{matrix}max \\ m\end{matrix} ( \frac{g ( {y}_{m}^{′} ) - {f}_{m}^{asp}}{{f}_{m}^{asp} - {f}_{m}^{ideal}} ) \qquad ( 6 )$$

$${E}_{2 , j} = \begin{matrix}max \\ m\end{matrix} ( \frac{g ( {y}_{m}^{″} ) - {f}_{m}^{asp}}{{f}_{m}^{asp} - {f}_{m}^{ideal}} ) \qquad ( 7 )$$

Note that, in the present disclosure, any component of the embodiment can be modified, or any component of the embodiment can be omitted.

### INDUSTRIAL APPLICABILITY

The present disclosure is suitable for a design assistance device and a design assistance method.

### REFERENCE SIGNS LIST

1: design data storage unit, 2: design assistance device, 3: display device, 11: data acquiring unit, 11a: design data converting unit, 12: preprocessing unit, 12a: interface unit, 13: data generating unit, 14: evaluation value calculating unit, 15: design data selecting unit, 21: data acquiring circuit, 22: preprocessing circuit, 23: data generating circuit, 24: evaluation value calculating circuit, 25: design data selecting circuit, 31: memory, 32: processor

1. A design assistance device comprising processing circuitry to acquire a plurality of pieces of design candidate data including a plurality of design parameters as candidates of design data of an electric motor, and to perform acquisition of a first evaluation value of each of the plurality of pieces of design candidate data,
to select top at least one piece of design candidate data having the first evaluation value that is relatively high as first design candidate data from among the plurality of pieces of design candidate data, and perform generation of second design candidate data including the plurality of design parameters from each piece of the first design candidate data,
to calculate a second evaluation value of each piece of the first design candidate data on a basis of the plurality of design parameters included in each piece of the first design candidate data, and calculate the second evaluation value of each piece of the second design candidate data on a basis of the plurality of design parameters included in each piece of the second design candidate data,
to select design candidate data to be used as design data of the electric motor from among the plurality of pieces of first design candidate data and the plurality of pieces of second design candidate data on a basis of the second evaluation value, and
to calculate the first evaluation value of each of the plurality of pieces of design candidate data using the plurality of design parameters included in each of the plurality of pieces of design candidate data, a desired level of each of the plurality of design parameters, and an ideal value of each of the plurality of design parameters, and output the first evaluation value of each of the plurality of pieces of design candidate data for the acquisition.

2. The design assistance device according to claim 1, wherein the processing circuitry is further configured to receive a setting of a desired level of each of the plurality of design parameters.

3. The design assistance device according to claim 2, wherein the processing circuitry generates display data for displaying each of the plurality of pieces of design candidate data and the first evaluation value of each of the plurality of pieces of design candidate data, and outputs the display data to a display device, and
the processing circuitry receives correction of the desired level of each of the plurality of design parameters.

4. The design assistance device according to claim 1, wherein the processing circuitry
generates each piece of the second design candidate data in such a manner that a value of one of the plurality of design parameters included in each piece of the second design candidate data is different from a value of a design parameter corresponding to the one of the plurality of design parameters included in the first design candidate data being a generation source of the generation.

5. A design assistance method comprising:
acquiring a plurality of pieces of design candidate data including a plurality of design parameters as candidates of design data of an electric motor, and to perform acquisition of a first evaluation value of each of the plurality of pieces of design candidate data;
selecting top at least one piece of design candidate data having the first evaluation value that is relatively high as first design candidate data from among the plurality of pieces of design candidate data, and performing generation of second design candidate data including the plurality of design parameters from each piece of the first design candidate data;
calculating a second evaluation value of each piece of the first design candidate data on a basis of the plurality of design parameters included in each piece of the first design candidate data, and calculating the second evaluation value of each piece of the second design candidate data on a basis of the plurality of design parameters included in each piece of the second design candidate data;
selecting design candidate data to be used as design data of the electric motor from among the plurality of pieces of first design candidate data and the plurality of pieces of second design candidate data on a basis of the second evaluation value; and
calculating the first evaluation value of each of the plurality of pieces of design candidate data using the plurality of design parameters included in each of the plurality of pieces of design candidate data, a desired level of each of the plurality of design parameters, and an ideal value of each of the plurality of design parameters, and outputting the first evaluation value of each of the plurality of pieces of design candidate data for the acquisition.
